(19) United States
(12) Patent Application Publication
(10) Pub. No.: US 2023/0060863 A1
(43) Pub. Date: Mar. 2, 2023

(54) DETERMINATION OF SUCCESS RATES FOR REPROCESSING PAYMENTS

(71) Applicant: Hewlett-Packard Development Company, L.P., Spring, TX (US)

(72) Inventor: Shiyun YIE, Vancouver, WA (US)

(73) Assignee: Hewlett-Packard Development Company, L.P., Spring, TX (US)

(21) Appl. No.: 17/410,388

(22) Filed: Aug. 24, 2021

(51) Int. Cl. G06Q 20/02; G06Q 20/18; G06Q 40/02; G06Q 10/06; G06F 3/12

(52) U.S. Cl. CPC G06Q 20/02; G06Q 20/18; G06Q 40/02; G06Q 10/067; G06F 3/1219; G06F 3/1229

(57) ABSTRACT

According to examples, an apparatus may include a processor and a memory on which are stored computer-readable instructions that, when executed by the processor, may cause the processor to receive information regarding a payment failure associated with a payment for printed pages at a printer. In some examples, the payment failure may be correlated to a payment method. Based on the information regarding the payment failure, the processor may determine a success rate in retrying the payment using the payment method, and based on the determined success rate being greater than a predetermined threshold, the processor may reprocess the payment using the payment method.

### BACKGROUND

Printers may include consumables, such as ink cartridges, toner, or the like, which may be replaced as the consumables are consumed. In some examples, payment transactions for the replacement consumables may be made periodically, for instance, according to a payment plan. Each payment transaction may have a transaction cost.

### BRIEF DESCRIPTION OF THE DRAWINGS

Features of the present disclosure are illustrated by way of example and not limited in the following figure(s), in which like numerals indicate like elements, in which:

FIG. 1 depicts a block diagram of an example apparatus that may determine a success rate in retrying a payment using a payment method and reprocessing the payment based on the determined success rate;

FIG. 2 shows a block diagram of an example system within which the example apparatus depicted in FIG. 1 may be implemented;

FIG. 3 shows a flow diagram of an example method for simulating costs associated with a payment plan correlated to a plurality of payment frequencies and identifying a payment frequency based on the simulated costs;

and

FIG. 4 depicts a block diagram of an example non-transitory computer-readable medium that may have stored thereon computer-readable instructions to determine a success rate in retrying a payment using a payment method and reprocessing the payment and/or setting a printer in a suspend mode based on the determined success rate.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Generally, printers may include consumables, such as ink cartridges, toner, and other supplies, such as printer drums, printer fuser units, and/or the like, which may be replaced over time and/or as the consumables are consumed. In some examples, the consumables may be purchased through a subscription plan, in which the consumables, such as the ink cartridges or toner, may be shipped to a user based on monitored usage, and payment for such shipments may be made automatically according to a payment plan as set forth in the subscription plan. Similar types of subscription plans may be employed for other types of devices as well. However, in some cases, a concern with automated payment for consumables may be that costs associated with payment transactions, as well as the number of transactions, may become relatively high.

By way of particular example and for purposes of illustration, in some subscription plans for consumables that automatically charge customers for supplies, the processor may retry payment transactions a predetermined number of times in cases where the payment transactions have failed. In these instances, a flat transaction fee may be charged by the payment processor for each retry attempt, and in some instances, a relatively large number of retry attempts may result in the transaction fees amounting to a relatively high percentage of the total price of a payment plan.

In some examples, relatively large amounts in transaction fees may result from printer usage patterns. By way of particular example, a particular payment frequency may be associated with different payment plans, and each transaction may be charged a flat transaction fee. In cases where the flat transaction fees are relatively high compared to the amount of each transaction (for instance, transaction fees charged by payment processors may reach 40% or more of the plan price), a problem may arise related to perceived overage costs. For instance, in a case where a user may print a large amount of pages in excess of monthly allotted pages in a particular month, large overage charges may result due to flat transaction fees which may be charged with each print job above the predetermined number of allowed print jobs per month.

Disclosed herein are apparatuses, systems, methods, and computer-readable media in which a processor may optimize costs associated with payment transactions, for instance, through an optimized retry policy and an optimized payment frequency (also referred to herein as a charge cadence). In some examples, the processor may optimize a retry policy for failed transactions based on reasons for the failed transactions, such as based on error codes correlated to the failed transactions. The processor may determine whether a retry for the failed transactions would be successful based on the reasons for the failed transactions. In some examples, the processor may optimize the charge cadence to reduce the amount of potential transaction fees. For instance, the processor may determine an optimal charge cadence based on printer usage history and payment data, including the plan price, the payment processor, the transaction fees associated with the payment processor, print history, overages, and/or the like.

In some examples, the processor may receive information regarding a payment failure associated with a payment for printed pages at a printer. The payment failure may be correlated to a payment method. Based on the information regarding the payment failure, the processor may determine a success rate in retrying the payment using the payment method. Based on the determined success rate being greater than a predetermined threshold, the processor may reprocess the payment using the payment method.

In some examples, the processor may receive information regarding usage history of a printer and a payment plan, which may have a first payment frequency. The processor may determine whether payments correlated with the payment plan include transaction costs greater than a predetermined threshold amount based on the received information. The processor may simulate costs associated with the payment plan correlated to a plurality of payment frequencies based on the usage history and may identify a second payment frequency among the plurality of payment frequencies based on the simulated costs. The second payment frequency may have estimated transaction costs that may be less than the predetermined threshold amount. The processor may process subsequent payments for usage of the printer based on the second payment frequency.

By enabling optimization of a payment transaction retry policy and optimization of a charge cadence for payment, the processor may reduce consumption of processing resources and load on the servers by reducing a number of transactions for the payment. In some examples, the processor may optimize a retry policy, which may allow the processor to eliminate transactions for which success rates may be low, which may reduce consumption of processing resources and load on the server due to unsuccessful retry attempts. In some examples, the processor may optimize the charge cadence, for instance, to increase the time period between transactions, thereby reducing the overall number of transactions, which may result in reduced consumption of processing resources and sever load.

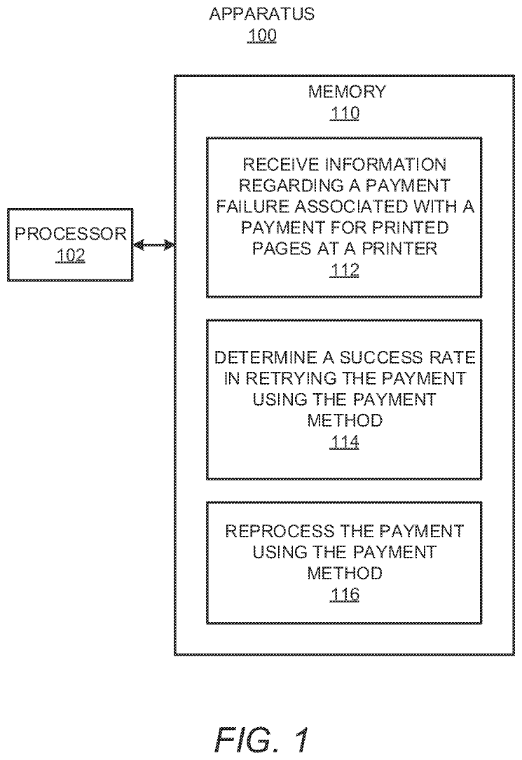

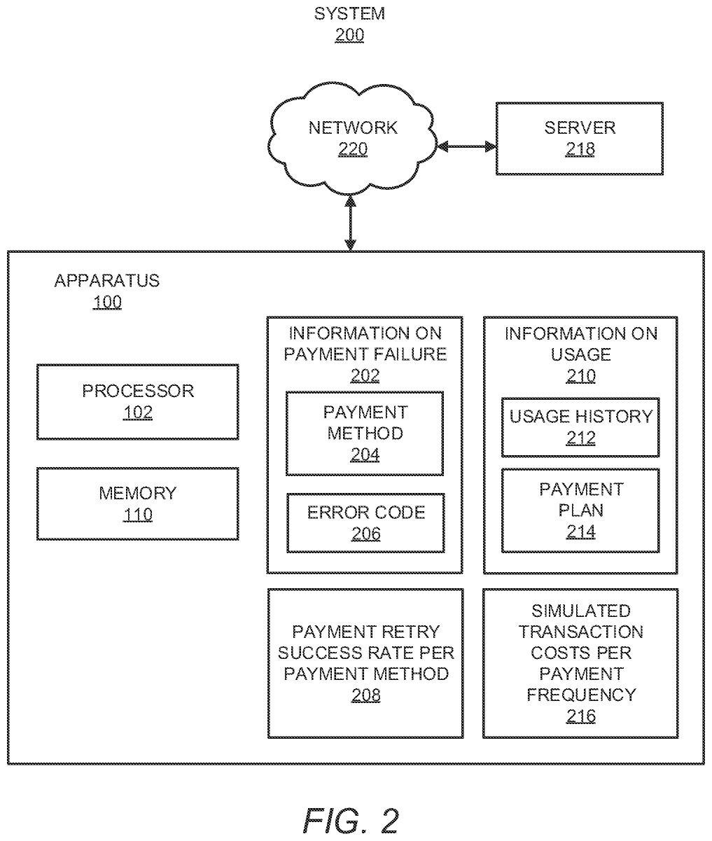

Reference is first made to FIGS. 1 and 2. FIG. 1 shows a block diagram of an example apparatus 100 that may determine a success rate in retrying a payment using a payment method and reprocessing the payment based on the determined success rate. FIG. 2 shows a block diagram of an example system 200 within which the example apparatus 100 depicted in FIG. 1 may be implemented. It should be understood that the apparatus 100 depicted in FIG. 1 and/or the system 200 depicted in FIG. 2 may include additional features and that some of the features described herein may be removed and/or modified without departing from the scopes of the apparatus 100 and/or the system 200.

In some examples, the apparatus 100 may be implemented in a computing device, such as a server, a printer, such as a thermal inkjet printer, a piezoelectric inkjet printer, a laser printer, and/or the like. As shown, the apparatus 100 may include a processor 102 and a non-transitory computer-readable medium, e.g., a memory 110. The processor 102 may be a semiconductor-based microprocessor, a central processing unit (CPU), an application specific integrated circuit (ASIC), a field-programmable gate array (FPGA), and/or other hardware device. Although the apparatus 100 is depicted as having a single processor 102, it should be understood that the apparatus 100 may include additional processors and/or cores without departing from a scope of the apparatus 100 and/or system 200. In this regard, references to a single processor 102 as well as to a single memory 110 may be understood to additionally or alternatively pertain to multiple processors 102 and/or multiple memories 110.

The memory 110 may be an electronic, magnetic, optical, or other physical storage device that contains or stores executable instructions. The memory 110 may be, for example, Read-Only Memory (ROM), flash memory, solid state drive, Random-Access memory (RAM), an Electrically Erasable Programmable Read-Only Memory (EEPROM), a storage device, an optical disc, or the like. The memory 110 may be a non-transitory computer-readable medium. The term “non-transitory” does not encompass transitory propagating signals.

As shown in FIG. 1, the processor 102 may execute instructions 112-116 to determine a success rate in retrying a payment using a payment method and reprocessing the payment based on the determined success rate. The instructions 112-116 may be computer-readable instructions, e.g., non-transitory computer-readable instructions. In other examples, the apparatus 100 may include hardware logic blocks or a combination of instructions and hardware logic blocks to implement or execute functions corresponding to the instructions 112-116.

The processor 102 may fetch, decode, and execute the instructions 112 to receive information 202 regarding a payment failure associated with a payment for printed pages at a printer. The payment failure may be correlated to a particular payment method 204. Based on the received information 202, the processor 102 may identify reasons for the payment failure. In some examples, the processor 102 may identify an error code 206 correlated with the payment failure, and may identify the reasons for the payment failure based on the error code 206.

The error code 206 may be associated with a payment processor, a geographical region, a payment type, a credit card type, or a combination thereof. In some examples, different payment processors may define different sets of error codes based on various criteria. By way of particular example and for purposes of illustration, the error code 206 may indicate that the payment failed due to insufficient funds, due to the payment being an amount that exceeds a predefined maximum value, due to the payment being made using an expired credit card, due to the payment being made using an invalid/expired credit card alias, and/or the like, and the processor 102 may identify the reasons associated with the payment failure based on information related to the error code 206.

The processor 102 may fetch, decode, and execute the instructions 114 to determine, based on the information 202 regarding the payment failure, a success rate 208 in retrying the payment using the payment method 204. In some examples, the processor 102 may determine the success rate 208 in retrying the payment using the payment method 204 correlated to the identified error code 206. The processor 102 may determine the success rate 208 in retrying the payment using the payment method 204 based on various types of information, including a payment processor, a geographical region, a payment type, a card type correlated to the payment method, and/or the like.

By way of particular example and for purposes of illustration, a first error code 206 may be associated with an attempted payment for an amount that exceeds a predefined maximum value, and a second error code 206 may be associated with an expired credit card, in which a card expiration date may be prior to a current date. The first error code 206 may be an error code which may have a relatively high retry success rate and the second error code 206 may be an error code which may have a relatively low retry success rate. The processor 102 may determine the success rate 208 for retrying the payment for the first error code 206 associated with an attempted payment for an amount that exceeds a predefined maximum value to be a first value, such as a 30% success rate, whereas the processor 102 may determine that the success rate 208 for retrying the payment for the second error code 206 associated with an expired credit card to be a second value, such as a 0% success rate, since the credit card is expired. The correlation of the success rates 208 to specific error codes 206 as well as the predetermined thresholds for the success rates 208 may be user-defined, based on historical data, experimentation, modeling, and/or the like.

The processor 102 may fetch, decode, and execute the instructions 116 to reprocess the payment using the payment method 204 based on the determined success rate 208 being greater than a predetermined threshold. By way of particular example, the processor 102 may process payment transactions based on a predetermined retry policy, such as to retry the payment transaction a predetermined number of times. Each retry attempt to process the payment transaction may incur a transaction cost. As such, based on the determined success rate 208 in retrying the payment using the payment method 204 correlated to the identified error code 206, the processor 102 modify the retry policy, which in some instances may reduce the transaction costs associated with the payment.

Continuing with the example in which the error code 206 is associated with an attempted payment for an amount that exceeds a predefined maximum value or an expired credit card, the processor 102 may determine that the success rate 208 for the first value associated with an attempted payment for an amount that exceeds a predefined maximum value, such as a 30% success rate, is greater than the predetermined threshold, and in this case, the processor 102 may reprocess the payment using the payment method 204 a predetermined number of times. In some examples, after reprocessing the payment the predetermined number of times prior to a successful payment transaction, the processor 102 may set the printer in a suspend mode to prevent operation of the printer based on a determination that the payment has failed the predetermined number of times.

In some examples, the processor 102 may determine that the success rate 208, for instance the second value associated with an expired credit card, such as a 0% success rate, is less than the predetermined threshold, and in this case, the processor 102 may adjust the predetermined retry policy and may not reprocess the payment using the payment method 204. In some examples, based on the determined success rate 208 being less than the predetermined threshold, the processor 102 may set the printer in a suspend mode to prevent operation of the printer without reprocessing the payment using the payment method 204. By way of particular example and for purposes of illustration, based on a determination that the success rate is less than the predetermined threshold, the processor 102 may set the printer in the suspend mode in lieu of reprocessing the payment using the payment method 204, which may prevent shipments of consumables and thus save on potential fulfilment costs. For instance, during a period of time while the processor 102 retries the payment using the payment method 204, a supply level for a consumable may trigger a shipment of the consumable, which may be costly if the user is not in good standing with payment.

In some examples, the processor 102 may determine a second payment method, which may have a success rate 208 greater than the predetermined threshold. The second payment method may be different than the payment method 204 associated with the payment failure. In some examples, such as when the success rate 208 for retrying the payment using the payment method 204 is less than the predetermined threshold, the processor 102 may reprocess the payment using the second payment method.

In some examples, the processor 102 may receive information 210 on usage of the printer. The information 210 on usage may include usage history 212 of the printer and a payment plan 214. In some examples, the payment plan 214 may define the payment method 204 and a first payment frequency for processing payments. The processor 102 may determine whether the payment correlated with the payment method 204 includes transaction costs above a predetermined threshold amount.

The processor 102 may simulate costs 216 correlated to a plurality of payment frequencies based on the usage history 212 of the printer, and the processor 102 may identify a second payment frequency among the plurality of payment frequencies based on the simulated costs 216. In some examples, the processor 102 may identify as the second payment frequency a payment frequency among the plurality of payment frequencies that has estimated transaction costs which are less than the predetermined threshold amount. The processor 102 may process subsequent payments for usage of the printer based on the second payment frequency. The processor 102 may adjust the payment frequency of the payment plan 214 to the second payment frequency, which may be different than the first payment frequency.

In some examples, the simulated costs 216 correlated to the plurality of payment frequencies may include estimated transaction costs based on the respective payment frequency. By way of particular example, in cases in which the processor 102 may detect printer usage in excess of plan limits for a particular month, and may identify relatively large transaction costs associated with the excess usage, the processor 102 may change the payment frequency to the identified second payment frequency, for instance to decrease the payment frequency from a monthly frequency to an annual frequency.

The processor 102 may reduce a number of transactions to process the subsequent payments, for instance, based on the decreased payment frequency. For instance; the second payment frequency may have a fewer number of transactions than the first payment frequency.

In some examples, the processor 102 may update the payment plan 214 and store the updated payment plan 214 on the server 218, which may be connected to the apparatus 100 via a network 220. In some examples, the processor 102 may access the information 202 on the payment failure and/or the information 210 on usage from a server 218 via a network 220.

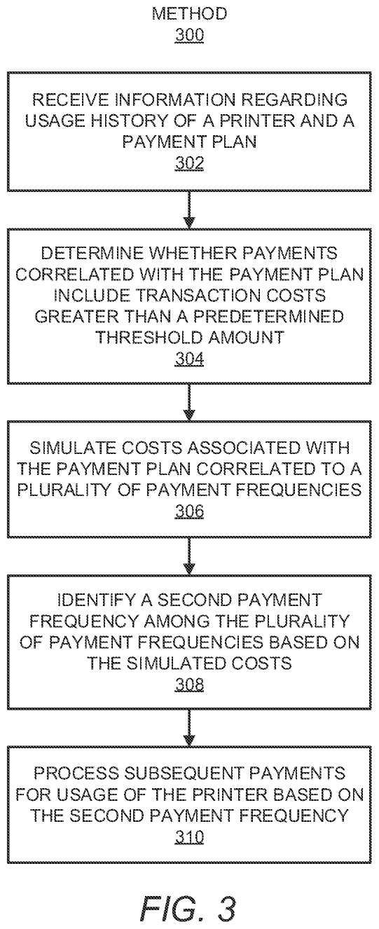

Various manners in which the processor 102 may operate are discussed in greater detail with respect to the method 300 depicted in FIG. 3. FIG. 3 depicts a flow diagram of an example method 300 for simulating costs 216 associated with a payment plan 214 correlated to a plurality of payment frequencies and identifying a payment frequency based on the simulated costs 216. It should be understood that the method 300 depicted in FIG. 3 may include additional operations and that some of the operations described therein may be removed and/or modified without departing from the scope of the method 300. The description of the method 300 is made with reference to the features depicted in FIGS. 1 and 2 for purposes of illustration.

At block 302, the processor 102 may receive information 210 regarding usage history 212 of a printer and a payment plan 214. The payment plan 214 may have a first payment frequency, such as weekly, monthly, annually, or the like.

At block 304, the processor 102 may determine whether payments correlated with the payment plan 214 include transaction costs greater than a predetermined threshold amount based on the received information 210 on printer usage.

At block 306, the processor 102 may simulate costs, such as the simulated transaction costs 216, associated with the payment plan correlated to a plurality of payment frequencies based on the usage history 212.

At block 308, the processor 102 may identify a second payment frequency among the plurality of payment frequencies based on the simulated costs 216. The processor 102 may determine the second payment frequency as having estimated transaction costs that are less than the predetermined threshold amount.

At block 310, the processor 102 may process subsequent payments for usage of the printer based on the second payment frequency. In some examples, the simulated costs 216 correlated to the plurality of payment frequencies may include estimated transaction costs based on the respective payment frequency.

In some examples, the processor 102 may determine the second payment frequency to be less than the first payment frequency, and as such, the processor 102 may reduce a number of transactions to process the subsequent payments, as the second payment frequency may have a fewer number of transactions than the first payment frequency.

In some examples, the processor 102 may receive information regarding a payment failure for a payment at the printer, such as the information 202 depicted in FIG. 2. The payment failure may be correlated to a particular payment method 204. Based on the information 202 regarding the payment failure, the processor 102 may determine a success rate, such as the success rate 208 depicted in FIG. 2, in retrying the payment using the payment method 204. Based on the determined success rate 208 being greater than a predetermined threshold, the processor 102 may reprocess the payment using the payment method 204.

In some examples, based on the determined success rate 208 being greater than the predetermined threshold, the processor 102 may reprocess the payment a predetermined number of times using the payment method 204. Based on failure of the payment after reprocessing the payment the predetermined number of times, the processor 102 may set the printer in a suspend mode to prevent operation of the printer. In some examples, based on the determined success rate being less than the predetermined threshold, the processor 102 may set the printer in the suspend mode to prevent operation of the printer without reprocessing the payment using the payment method 204.

By way of particular example and for purposes of illustration, the processor 102 may determine, based on the received information 202, that the payment failure is due to an expired credit card. In these instances, the processor 102 may determine that the success rate 208 for retrying the payment for the payment method 204 in which the credit card is expired is, for instance, about 0%, which may be less than the predetermined threshold. In these instances, the processor 102 may forego reprocessing the payment using the payment method 204, and may set the printer in the suspend mode.

Some or all of the operations set forth in the method 300 may be included as utilities, programs, or subprograms, in any desired computer accessible medium. In addition, the method 300 may be embodied by computer programs, which may exist in a variety of forms both active and inactive. For example, they may exist as computer-readable instructions, including source code, object code, executable code or other formats. Any of the above may be embodied on a non-transitory computer-readable storage medium.

Examples of non-transitory computer-readable storage media include computer system RAM, ROM, EPROM, EEPROM, and magnetic or optical disks or tapes. It is therefore to be understood that any electronic device capable of executing the above-described functions may perform those functions enumerated above,

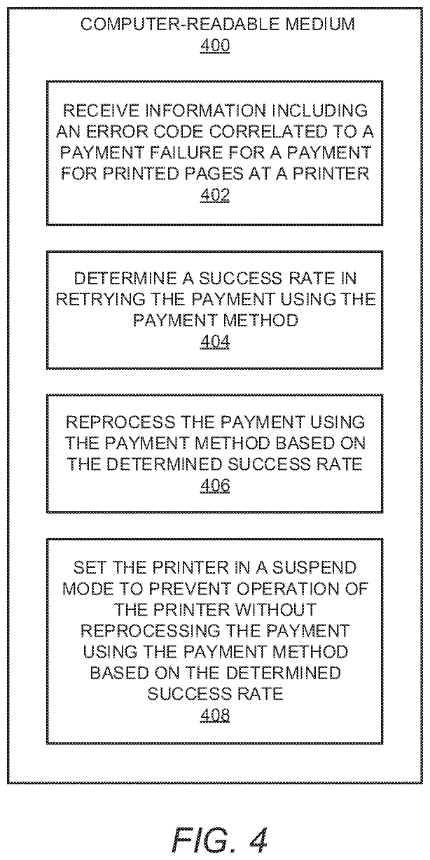

Turning now to FIG. 4, there is shown a block diagram of a non-transitory computer-readable medium 400 that may have stored thereon computer-readable instructions to determine a success rate 208 in retrying a payment using a payment method 204 and reprocessing the payment and/or setting the printer in a suspend mode based on the determined success rate 208. It should be understood that the computer-readable medium 400 depicted in FIG. 4 may include additional instructions and that some of the instructions described herein may be removed and/or modified without departing from the scope of the computer-readable medium 400 disclosed herein. The computer-readable medium 400 may be a non-transitory computer-readable medium. The term “non-transitory” does not encompass transitory propagating signals.

The computer-readable medium 400 may have stored thereon computer-readable instructions 402-408 that a processor, such as the processor 102 depicted in FIGS. 1-2, may execute. The computer-readable medium 400 may be an electronic, magnetic, optical, or other physical storage device that contains or stores executable instructions. The computer-readable medium 400 may be, for example, Random-Access memory (RAM), an Electrically Erasable Programmable Read-Only Memory (EEPROM), a storage device, an optical disc, or the like,

The processor may fetch, decode, and execute the instructions 402 to receive information 202, which may include an error code 206 correlated to a payment failure for a payment for printed pages at a printer. The error code 206 may be correlated to a payment method 204.

The processor may fetch, decode, and execute the instructions 404 to determine a success rate 208 in retrying the payment using the payment method 204 based on the received information 202 regarding the payment failure.

The processor may fetch, decode, and execute the instructions 406 to reprocess the payment using the payment method 204 based on the determined success rate 208 relative to a predetermined threshold. In some examples, based on the determined success rate 208 being greater than the predetermined threshold, the processor may reprocess the payment a predetermined number of times using the payment method 204. In some examples, based on failure of the payment after reprocessing the payment the predetermined number of times, the processor may set the printer in a suspend mode to prevent operation of the printer.

The processor may fetch, decode, and execute the instructions 408 to set the printer in the suspend mode to prevent operation of the printer without reprocessing the payment using the payment method 204. For instance, based on the determined success rate 208 being less than the predetermined threshold, the processor may set the printer in the suspend mode without reprocessing the payment using the payment method 204.

In some examples, the processor may receive information 210 regarding usage history 212 of the printer and a payment plan 214 associated with the payment for printed pages at the printer. The processor may determine whether transaction costs associated with the payment plan 214 are greater than a predetermined threshold amount. The transaction costs may be based on a first payment frequency.

The processor may simulate costs 216 associated with the payment plan 214 correlated to a plurality of payment frequencies based on the usage history 212 of the printer. In some examples, the processor may identify a second payment frequency among the plurality of payment frequencies based on the simulated costs 216. The processor may determine the second payment frequency to have estimated transaction costs that may be less than the predetermined threshold amount. The processor may process subsequent payments for printed pages at the printer based on the second payment frequency.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims and their equivalents in which all terms are meant in their broadest reasonable sense unless otherwise indicated.

What is claimed is:

1. An apparatus comprising:
a processor; and
a memory on which are stored machine-readable instructions that when executed by the processor, cause the processor to:
receive information regarding a payment failure associated with a payment for printed pages at a printer, the payment failure being correlated to a payment method:
based on the information regarding the payment failure, determine a success rate in retrying the payment using the payment method; and
based on the determined success rate being greater than a predetermined threshold, reprocess the payment using the payment method.

2. The apparatus of claim 1, wherein the instructions further cause the processor to:
based on the determined success rate being greater than the predetermined threshold, reprocess the payment using the payment method a predetermined number of times; and
based on a determination that the payment has failed after reprocessing the payment the predetermined number of times, set the printer in a suspend mode to prevent operation of the printer.

3. The apparatus of claim 1, wherein the instructions further cause the processor to:
based on the determined success rate being less than the predetermined threshold, set the printer in a suspend mode to prevent operation of the printer without reprocessing the payment using the payment method.

4. The apparatus of claim 1, wherein the instructions further cause the processor to:
determine the success rate in retrying the payment using the payment method based on a payment processor, a geographical region, a payment type, and/or a card type correlated to the payment method.

5. The apparatus of claim 1, wherein the instructions further cause the processor to:
identify an error code correlated with the payment failure, the error code being associated with a payment processor, a geographical region, a payment type, a credit card type, or a combination thereof; and
determine the success rate in retrying the payment using the payment method correlated to the identified error code.

6. The apparatus of claim 1, wherein the instructions further cause the processor to:
determine a second payment method having a success rate greater than the predetermined threshold, the second payment method being different than the payment method associated with the payment failure; and
reprocess the payment using the second payment method.

7. The apparatus of claim 1, wherein the instructions further cause the processor to:
determine whether the payment correlated with a payment plan associated with the payment method includes transaction costs above a predetermined threshold amount, the payment plan having a first payment frequency;
simulate costs correlated to a plurality of payment frequencies based on a usage history of the printer;
identify a second payment frequency among the plurality of payment frequencies based on the simulated costs, the second payment frequency having estimated transaction costs that are less than the predetermined threshold amount; and
process subsequent payments for usage of the printer based on the second payment frequency, the second payment frequency being different than the first payment frequency.

8. A method comprising:
receiving, by a processor, information regarding usage history of a printer and a payment plan, the payment plan having a first payment frequency;
determining, by the processor, whether payments correlated with the payment plan include transaction costs greater than a predetermined threshold amount based on the received information;
simulating, by the processor, costs associated with the payment plan correlated to a plurality of payment frequencies based on the usage history;
identifying, by the processor, a second payment frequency among the plurality of payment frequencies based on the simulated costs, the second payment frequency having estimated transaction costs that are less than the predetermined threshold amount; and
processing, by the processor, subsequent payments for usage of the printer based on the second payment frequency.

9. The method of claim 8, wherein the simulated costs correlated to the plurality of payment frequencies include estimated transaction costs based on the respective payment frequency.

10. The method of claim 8, further comprising:
reducing a number of transactions to process the subsequent payments, wherein the second payment frequency has a fewer number of transactions than the first payment frequency.

11. The method of claim 8, further comprising:
receiving information regarding a payment failure for a payment at the printer, the payment failure being correlated to a payment method;
based on the information regarding the payment failure, determining a success rate in retrying the payment using the payment method; and
based on the determined success rate being greater than a predetermined threshold, reprocessing the payment using the payment method.

12. The method of claim 11, further comprising:
based on the determined success rate being greater than the predetermined threshold:
reprocessing the payment a predetermined number of times using the payment method; and
based on failure of the payment after reprocessing the payment the predetermined number of times, setting the printer in a suspend mode to prevent operation of the printer; or
based on the determined success rate being less than the predetermined threshold, setting the printer in the suspend mode to prevent operation of the printer without reprocessing the payment using the payment method.

13. A non-transitory computer-readable medium on which are stored machine-readable instructions that, when executed by a processor, cause the processor to:
receive information including an error code correlated to a payment failure for a payment for printed pages at a printer, the error code being correlated to a payment method;
based on the received information regarding the payment failure, determine a success rate in retrying the payment using the payment method; and
based on the determined success rate relative to a predetermined threshold:
reprocess the payment using the payment method; or
set the printer in a suspend mode to prevent operation of the printer without reprocessing the payment using the payment method.

14. The non-transitory computer-readable medium of claim 13, wherein the instructions cause the processor to:
based on the determined success rate being greater than the predetermined threshold:
reprocess the payment a predetermined number of times using the payment method; and
based on failure of the payment after reprocessing the payment the predetermined number of times, set the printer in the suspend mode to prevent operation of the printer; or
based on the determined success rate being less than the predetermined threshold, set the printer in the suspend mode without reprocessing the payment using the payment method.

15. The non-transitory computer-readable medium of claim 13, wherein the instructions cause the processor to:
receive information regarding usage history of the printer and a payment plan associated with the payment for printed pages at the printer;
determine whether transaction costs associated with the payment plan are greater than a predetermined threshold amount, the transaction costs being based on a first payment frequency;
simulate costs associated with the payment plan correlated to a plurality of payment frequencies based on the usage history of the printer;
identify a second payment frequency among the plurality of payment frequencies based on the simulated costs, the second payment frequency having estimated transaction costs that are less than the predetermined threshold amount; and
process subsequent payments for printed pages at the printer based on the second payment frequency.
